(19) United States
(12) Patent Application Publication
(10) Pub. No.: US 2015/0097369 A1
(43) Pub. Date: Apr. 9, 2015

(54) DUCT CONNECTION SYSTEM

(71) Applicant: GM GLOBAL TECHNOLOGY OPERATIONS LLC, Detroit, MI (US)

(72) Inventor: Giovanni F. Bernardo, Sao Paulo (BR)

(73) Assignee: GM GLOBAL TECHNOLOGY OPERATIONS LLC, Detroit, MI (US)

(21) Appl. No.: 14/045,407

(22) Filed: Oct. 3, 2013

(51) Int. Cl. F16L 21/00; F16L 21/04

(52) U.S. Cl. CPC F16L 21/002; F16L 21/007; F16L 21/04
USPC 285/361; 285/396

(57) ABSTRACT

An apparatus includes a first duct having a first outer surface and a first inner surface. The first outer surface has a protuberance thereon, and the first inner surface defines a first passageway having a first passageway opening. The apparatus also includes a second duct having a second outer surface and a second inner surface. The second inner surface defines a second passageway having a second passageway opening. The apparatus further includes a sleeve that defines a chamber having a first chamber opening and a second chamber opening. The sleeve also defines a slot. The sleeve is rotatably connected to the second duct, and the protuberance on the second outer surface is disposed within the slot such that the sleeve and the protuberance cooperate to couple the first duct to the second duct.

### TECHNICAL FIELD

This invention relates to coupling systems for connecting ducts.

### BACKGROUND

Automotive vehicles employ ducts to route air through various systems. For example, the air intake system for the engine may include ducts that interconnect an air filter and an intake manifold to convey air therebetween. Similarly, heating, ventilation, and air conditioning (HVAC) systems may employ ducts to transfer air into a passenger compartment.

### SUMMARY

An apparatus includes a first duct having a first outer surface and a first inner surface. The first outer surface has a protuberance thereon, and the first inner surface defines a first passageway having a first passageway opening. The apparatus also includes a second duct having a second outer surface and a second inner surface. The second inner surface defines a second passageway having a second passageway opening. The apparatus further includes a sleeve that defines a slot. The sleeve is rotatably connected to the second duct, and the protuberance on the second outer surface is disposed within the slot such that the sleeve and the protuberance cooperate to couple the first duct to the second duct.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic, section, side view of a duct assembly having a first duct, a second duct, and a sleeve connecting the first and second ducts;

FIG. 2 is a schematic, side view of the duct assembly of FIG. 1 showing the sleeve in section; and

FIG. 3 is a schematic, top view of the duct assembly of FIGS. 1 and 2.

### DETAILED DESCRIPTION

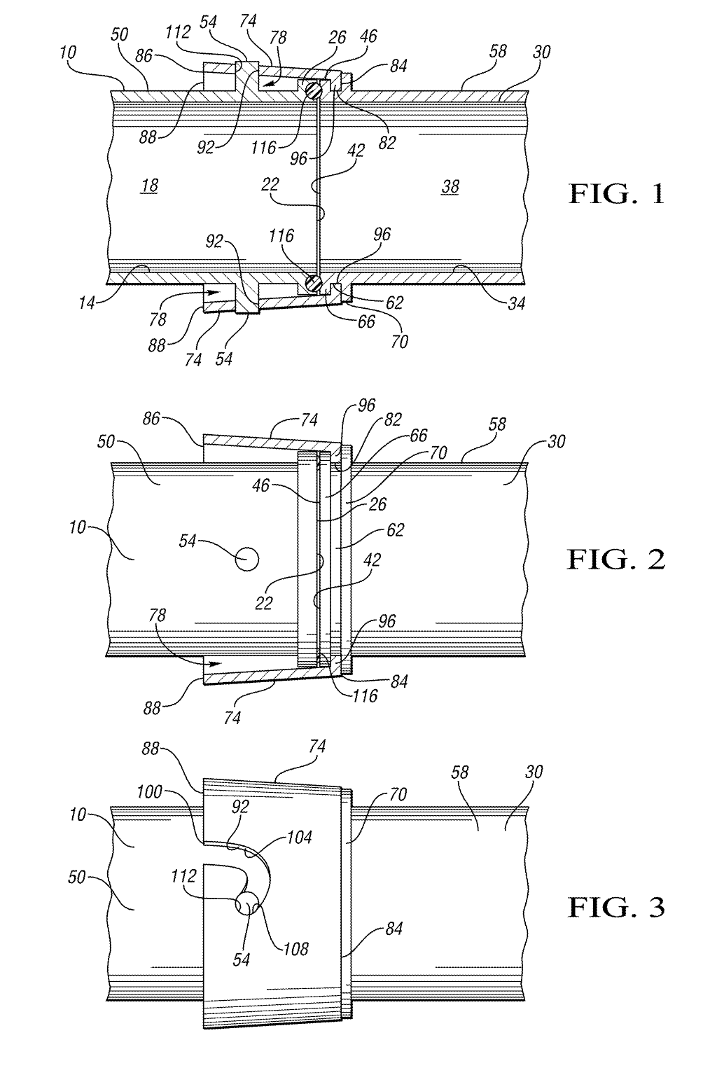

Referring to FIG. 1, a first duct 10 has a first inner surface 14 that defines a first passageway 18 having a first passageway opening 22 for conveying air or other gases. In the embodiment depicted, the first inner surface 14, and therefore the first passageway 18, is generally cylindrical. The first passageway opening 22 is at one end 26 of the first duct 10.

A second duct 30 has a second inner surface 34 that defines a second passageway 38 having a second passageway opening 42 for conveying air or other gases. In the embodiment depicted, the second inner surface 34, and therefore the second passageway 38, is generally cylindrical. The second passageway opening 42 is at one end 46 of the second duct 30.

The first duct 10 also has a first outer surface 50 that, in the embodiment depicted, is generally cylindrical. The first outer surface has at least one protuberance 54 thereon. In the embodiment depicted, two protuberances 54 extend radially outward from the first outer surface 50 near the end 26 of the first duct 10. The protuberances 54 and the duct 10 are part of a single piece of material in the embodiment depicted, though the protuberance or protuberances 54 may be one or more separate pieces of material attached to the first outer surface 50 within the scope of the claimed invention. The protuberances are cylindrical in the embodiment shown, but may have other shapes within the scope of the claims.

The second duct 30 also has a second outer surface 58 that defines an annular groove 62 near end 46. More specifically, the second outer surface 58 includes two annular protuberances 66, 70 that extend radially outward from the second outer surface 58 and extend completely around the circumference of the outer surface 58. The two annular protuberances 66, 70 cooperate to define the annular groove 62.

Referring to FIGS. 1 and 2, a sleeve 74 couples the first duct 10 to the second duct 30 such that the first passageway opening 22 is adjacent the second passageway opening 42, thereby placing the first passageway 18 and the second passageway 38 in fluid communication with one another. More specifically, the sleeve 74 defines a chamber 78 having a first chamber opening 82 formed in a first end 84 of the sleeve 74 and a second chamber opening 86 formed in a second end 88 of the sleeve 74. The sleeve 74 in the embodiment depicted is generally frusto-conical in shape, i.e., the diameter of the sleeve 74 (both inner and outer diameter) increases with increasing distance from the first end 84. However, the sleeve 74 may have other geometries, such as cylindrical, within the scope of the claims. The sleeve 74 also defines at least one slot 92. In the embodiment depicted, the sleeve defines two slots 92.

The sleeve 74 is rotatably connected to the second duct 30 such that the sleeve 74 is selectively rotatable with respect to the second duct 30. More specifically, in the embodiment depicted, the sleeve 74 includes an annular flange 96 that is concentrically disposed around the second duct 30 and that extends into the annular groove 62 in the outer surface 58 of the second duct 30. The interaction between the flange 96 and the protuberances 66, 70 limits or restricts translation of the sleeve 74 relative to the second duct 30 but permits rotation of the sleeve 74 relative to the second duct 30. The end 46 (and opening 42) of the second duct 30 extends inside the chamber 78.

Each of the protuberances 54 is engageable with the sleeve 74 inside a respective one of the slots 92 such that the sleeve 74 and the protuberances 54 cooperate to couple the first duct 10 to the second duct 30. More specifically, and with reference to FIG. 3, each of the slots 92 has a respective slot opening 100 formed in the second end 88 of the sleeve 74. It should be noted that the two slots 92 are located on opposite sides of the sleeve 74, and therefore only one of the slots 92 is shown in FIG. 3. However, both slots 92 are identical. Similarly, the two protuberances 54 are located on opposite sides of the first duct 10, and therefore only one of the protuberances 54 is shown in FIG. 3.

Each of the slots 92 is generally J-shaped or hook-shaped, as shown in FIG. 3. More specifically, each slot 92 has a first portion 104 that extends from the slot opening 100 in the second end 88 toward the first end 84, and a second portion 108 that extends back toward the second end 88, but terminates at a slot end 112 prior to reaching the second end 88 of the sleeve 74.

An elastomeric seal member (shown at 116 in FIGS. 1 and 2) is operatively connected to the end 26 of the first duct 10. The seal member 116 is annular in shape and surrounds the first passageway opening 22. Alternatively, the seal member 116 may be attached to the end 46 of the second duct 30 and surround the second passageway opening 42 within the scope of the claims.

To couple the second duct 30 to the first duct 10, the end 26 of the first duct 10 is inserted into the chamber 78 through the second chamber opening 86; during insertion of the end 26 into the chamber 78, the first duct 10 is oriented such that each of the protuberances 54 is aligned with a respective one of the slot openings 100. Further movement of the first duct 10 into the chamber 78 causes each protuberance 54 to enter a respective one of the slots 92 via a respective one of the openings 100, and more particularly, each protuberance enters, and travels through, a respective first slot portion 104. The width of the slots 92 is marginally greater than the width of the protuberances 54, and thus movement of the protuberances 54 relative to the sleeve 74 is substantially limited to movement along the slots 92.

As the end 26 of the first duct 10 moves closer to the end 46 of the second duct 30, the seal member 116 contacts end 46 and is subjected to compressive strain. When each of the protuberances 54 reaches the intersection of a slot portion 104 and a slot portion 108, further movement of the first duct 10 toward the second duct 30 is prevented by interaction between the protuberances 54 and the sleeve 74. At this point, the sleeve 74 is rotated relative to the second duct 30 so that the protuberances 54 enter a respect second portion 108.

The elastomeric seal member 116 is under elastic, compressive strain, and thus exerts a force on the first duct 10 urging the first duct 10 away from the second duct 30, which causes the protuberances 54 to traverse their respective second portions 108 until they reach a respective end 112. The force from the compressed seal 116 maintains the protuberances 54 against a respective slot end 112, and thus the sleeve 74 and the protuberances 54 cooperate to couple the first duct 10 to the second duct 30. As shown in the Figures, when the protuberances 54 are engaged with the sleeve 74 at slot ends 112, both ends 26, 46 of the first and second ducts 10, 30 are adjacent one another inside the chamber 78, and thus the passageway openings 22, 42 are adjacent one another, thereby placing the first and second passageways 18, 38 in fluid communication with one another. Seal member 116 creates a seal between the openings 22, 42 and the surrounding atmosphere. The frusto-conical shape of the chamber 78 facilitates insertion of the first duct 10 into the chamber 78 by providing the second chamber opening 86 with a larger diameter, and the narrowing diameter of the chamber 78 then guides the first passageway opening 22 into alignment with the second passageway opening 42.

It should be noted that in some embodiments, and within the scope of the claims, the first and second ducts 10, 30 may include features that function to ensure that the first duct 10 is aligned with the second duct 30 in a particular manner. For example, the first duct 10 may define a tab or protrusion (not shown) that is configured to enter a recess or hole in the second duct 30 when the ducts 10, 30 are aligned in the desired orientation; if the tab or protrusion is not aligned with the recess or hole, then connection of the ducts 10, 30 would be prevented.

While the best modes for carrying out the invention have been described in detail, those familiar with the art to which this invention relates will recognize various alternative designs and embodiments for practicing the invention within the scope of the appended claims.

1. An apparatus comprising:
a first duct having a first outer surface having a protuberance thereon, and a first inner surface defining a first passageway having a first passageway opening;
a second duct having a second outer surface and a second inner surface that defines a second passageway having a second passageway opening;
a sleeve defining a slot;
wherein the sleeve is rotatably connected to the second duct; and
wherein the protuberance is disposed within the slot such that the sleeve and the protuberance cooperate to couple the first duct to the second duct.

2. The apparatus of claim 1, wherein the second outer surface defines an annular groove; and
wherein the sleeve includes an annular flange that extends into the annular groove.

3. The apparatus of claim 1, wherein the sleeve defines a chamber having a first chamber opening and a second chamber opening; and
wherein the first and second ducts are at least partially disposed within the chamber.

4. The apparatus of claim 3, wherein the chamber is generally frusto-conical.

5. The apparatus of claim 3, wherein the first and second passageway openings are disposed within the chamber.

6. The apparatus of claim 5, wherein the sleeve couples the first duct to the second duct such that the first and second passageway openings are adjacent one another, thereby providing fluid communication between the first and second passageways.

7. The apparatus of claim 6, further comprising a seal member that is compressed between the first and second ducts thereby forming a face seal around the first and second openings.

8. The apparatus of claim 6, wherein the sleeve has a first end and a second end;
wherein the first chamber opening is formed in the first end;
wherein the second chamber opening is formed in the second end; and
wherein the slot has a slot opening in the second end.

9. The apparatus of claim 8, wherein the slot is generally J-shaped.

10. An apparatus comprising:
a first duct having a first outer surface having a protuberance thereon, and a first inner surface defining a first passageway having a first passageway opening;
a second duct having a second outer surface and a second inner surface that defines a second passageway having a second passageway opening;
a sleeve defining a chamber having a first chamber opening and a second chamber opening and defining a slot;
wherein the sleeve is rotatably connected to the second duct; and
wherein the protuberance is engageable with the sleeve inside the slot such that the sleeve and the protuberance cooperate to couple the first duct to the second duct.

11. The apparatus of claim 10, wherein the second outer surface defines an annular groove; and
wherein the sleeve includes an annular flange that extends into the annular groove.

12. The apparatus of claim 10, wherein the chamber is generally frusto-conical.

13. The apparatus of claim 10, wherein the second duct is at least partially disposed within the chamber.

14. The apparatus of claim 13, wherein the second passageway opening is disposed within the chamber.

15. The apparatus of claim 14, further comprising a seal member operatively connected to one of the first and second ducts and positioned such that the seal member is compressed between the first and second ducts thereby forming a face seal around the first and second openings when the protuberance is engaged with the sleeve inside the slot.

16. The apparatus of claim 10, wherein the sleeve has a first end and a second end;
wherein the first chamber opening is formed in the first end;
wherein the second chamber opening is formed in the second end; and
wherein the slot has a slot opening in the second end.

17. The apparatus of claim 16, wherein the slot has is generally J-shaped.
